(19) United States
(12) Patent Application Publication
(10) Pub. No.: US 2024/0005364 A1
(43) Pub. Date: Jan. 4, 2024

(54) METHOD AND DEVICE FOR EDITING ADVERTISEMENT CONTENT

(71) Applicant: KINEMASTER CORPORATION, Seoul (KR)

(72) Inventors: Ha Young RYU, Seoul (KR); Jae Won CHUNG, Seoul (KR)

(21) Appl. No.: 18/251,779

(22) PCT Filed: Nov. 8, 2021
(86) PCT No.: PCT/KR2021/016137

§ 371 Date: May 4, 2023

(30) Foreign Application Priority Data
Nov. 9, 2020 (KR) 10-2020-0148865
Nov. 8, 2021 (KR) 10-2021-0152200

(51) Int. Cl. G06Q 30/0241; G06Q 30/0242; G06F 3/04817

(52) U.S. Cl. CPC G06Q 30/0276; G06Q 30/0244; G06F 3/04817; G06F 2203/04803

(57) ABSTRACT

Disclosed herein a method for editing advertising contents and apparatus thereof. The method for editing an advertising content, performed by a computing device including at least one processor, includes extracting an editable element from a loaded advertising content and presenting the editable element; receiving, by a user input, the presented editable element; selecting, by the user input, an insertion element for the editable element; and editing the advertising content based on the selected insertion element.

### TECHNICAL FIELD

The present disclosure relates to a method and apparatus for editing advertising contents and, more particularly, to a method and apparatus for editing advertising contents that are capable of maximizing an advertising effect through personalized advertising edits.

### BACKGROUND ART

Recently, portable terminals such as smart phones and tablets are widely used, and the performance advances of such portable terminals and the development of wireless communication technology allow users to shoot, edit, and share videos using portable terminals.

However, due to limitations in LCD size and hardware performance, users cannot edit videos by using a portable terminal as smoothly as in the general PC environment. In order to alleviate such inconvenience, user demand for a video editing method that can be used in a portable terminal is increasing.

In addition, as the needs of users of portable terminals are on the rise, the performance of camera, display and other hardware in portable terminals are being advanced, and many functions or services that used to be available only in the PC environment have been replaced by portable terminals. Particularly, as each portable terminal has a camera as a basic component, there is an increase in the needs of users for editing images or videos shot by cameras.

Meanwhile, advertising is performed through PC-based web pages, portal sites, banners, links and/or separate windows, and the like, but the wide spread of portable terminals like smart phones in recent years leads to a dramatic increase of mobile advertisements rather than PC-based advertisements.

While mobile advertisements can be provided random people having portable terminals, they can also selectively given to a plurality of portable terminal users targeted with respect to an advertised product or service in order to maximize an advertising effect which can finally result in the purchase of the product or service. Furthermore, to enhance the advertising effect, mobile or PC-based advertising contents may be produced in various forms including not only texts and images but also videos. In the latter case, advertising contents may be provided via various video platforms like YouTube and VLOG. In addition, to propagate an advertising content to as many users as possible, a benefit is offered to users who actively share an advertisement with other users. Such an advertising content is distributed only in a form that is produced by its advertiser and producer. An advertising content thus produced has a limitation in producing a strong advertising effect on a user who views it. In this regard, there is a method of editing an advertising content by a producer without distorting its concept and of providing an edited content to a user, but this method cannot reflect all the tastes of users who are interested in the advertised product and the like, and an expected advertising effect is not so clear as an inefficient cost of production. For this reason, in the field of advertising contents, various methods are under consideration which are expected not only to encourage individual users to actively share advertising contents but also to enable individual users to modify original advertising contents into creative and attractive forms to other users. Especially, an advertising content thus edited by an individual user may be modified into various forms of similar advertising contents, so that its advertising effect on user with different tastes can be maximized. Accordingly, advertising contents are being edited by using the above-mentioned video edit technique, and various methods are also being attempted to estimate an advertising effect of advertising contents.

### DISCLOSURE

### Technical Problem

A technical object of the present disclosure is to provide a method and apparatus for editing advertising contents and, more particularly, to provide a method and apparatus for editing advertising contents that are capable of maximizing an advertising effect through personalized advertising edits.

The technical objects of the present disclosure are not limited to the above-mentioned technical objects, and other technical objects that are not mentioned will be clearly understood by those skilled in the art through the following descriptions.

### Technical Solution

According to the present disclosure, there is provided a method for editing an advertising content, performed by a computing device including at least one processor, the method including: extracting an editable element from a loaded advertising content and presenting the editable element; receiving, by a user input, the presented editable element; selecting, by the user input, an insertion element for the editable element; and editing the advertising content based on the selected insertion element.

According to the embodiment of the present disclosure in the method, the editable element may include at least one of a media object constituting the advertising content, an editing tool for editing the advertising content, and category information that is designated for a concept of the advertising content.

According to the embodiment of the present disclosure in the method, the editing tool may include an editing function for giving an additional effect to a medium constituting the advertising content.

According to the embodiment of the present disclosure in the method, the category information may include at least one of a media form of the advertising content, which allows the concept to be modified, connection information between the media object, and information on an insertable additional effect.

According to the embodiment of the present disclosure in the method, the presenting of the editable element may include presenting the editable element to at least one of the media object, an editing user interface for editing the advertising content, and a predetermined area of an editing application that the computing device provides.

According to the embodiment of the present disclosure in the method, the extracting of the editable element may include extracting the editable element based on attribute information included in the advertising content, and the attribute information may record an editable element and a non-editable element as distinguished in the advertising content.

According to the embodiment of the present disclosure in the method, the receiving of the editable element may include receiving the user input, which selects the editable element, and receiving an insertion activation request according to the user input for the editable element.

According to the embodiment of the present disclosure in the method, the selecting of the insertion element may include presenting a plurality of candidate items, which are insertable into the editable element, and receiving a candidate item selected by the user input.

According to the embodiment of the present disclosure in the method, the method may further include: sharing the edited advertising content through a contents platform; generating evaluation information by evaluating the shared edited advertising content; and forwarding the evaluation information to the computing device and a server associated with provision of the advertising content.

According to the embodiment of the present disclosure in the method, the generating of the evaluation information may include generating first evaluation information based on at least one of an insertion element added to the edited advertising content and an advertising element maintained in the advertising content.

According to the embodiment of the present disclosure in the method, the first evaluation information may be generated based on at least one of a retention rate of the advertising element, importance information of the advertising element set in the advertising content, and modification degree information of the advertising content according to the insertion element.

According to the embodiment of the present disclosure in the method, the first evaluation information may be generated by at least one of the computing device and the server, and calculation criterion data in the modification degree information, which is used to calculate a modification degree of the edited advertising content, and the importance information are provided from the server.

According to the embodiment of the present disclosure in the method, the generating of the evaluation information may further include generating second evaluation information by collecting reaction information for the edited advertising content from another user of the contents platform.

According to another embodiment of the present disclosure, there is provided A computing device for editing an advertising content. The computing device including: a communication module; and a processor configured to control the computing device by transmitting to and receiving from the communication module. The processor is further configured to: present an editable element from a loaded advertising content, receive the presented editable element by a user input, select a replacement element for the editable element by the user input, and edit the advertising content based on the selected replacement element.

The features briefly summarized above for this disclosure are only exemplary aspects of the detailed description of the disclosure which follow, and are not intended to limit the scope of the disclosure.

### Advantageous Effects

According to the present disclosure, it is possible to provide a method and apparatus for editing advertising contents which are capable of maximizing an advertising effect through personalized advertising edits.

Effects obtained in the present disclosure are not limited to the above-mentioned effects, and other effects not mentioned herein may be clearly understood by those skilled in the art from the following description.

### BRIEF DESCRIPTION OF DRAWINGS

FIG. 1 a view exemplifying an electronic device to which various embodiments of the present disclosure are applied.

FIG. 2 is a view for describing a system hierarchy of an electronic device to which various embodiments of the present disclosure are applied.

FIG. 3 is a flowchart exemplifying an order of a video editing method to which various embodiments of the present disclosure are applied.

FIG. 4 is a view exemplifying an editing UI provided in a video editing UI control device according to various embodiments of the present disclosure.

FIG. 5A, FIG. 5B, FIG. 5C, FIG. 5D, and FIG. 5E are views exemplifying a clip editing UI provided in a video editing UI according to various embodiments of the present disclosure.

FIG. 6 is a flowchart depicting a method of editing an advertising content according to an embodiment of the present disclosure.

FIG. 7A, FIG. 7B, FIG. 7C, and FIG. 7D are views exemplifying a process where an advertising content is edited by an advertising content editing method according to an embodiment of the present disclosure.

FIG. 8 is a flowchart of an evaluation process of an edited advertising content according to another embodiment of the present disclosure.

### MODE FOR INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

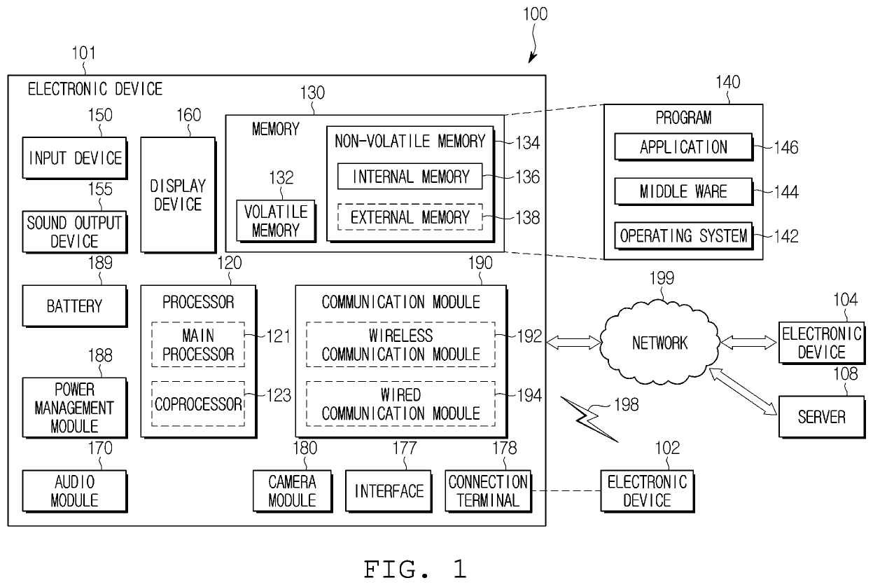

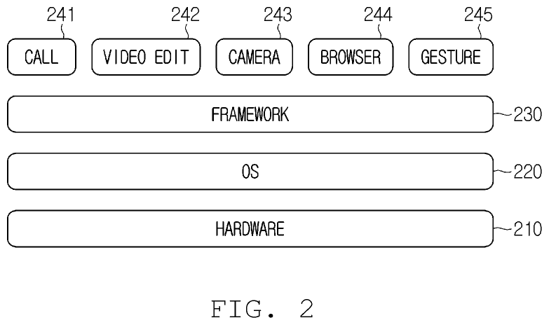

FIG. 1 a view exemplifying an electronic device to which various embodiments of the present disclosure are applied. That is, FIG. 1 is a block diagram showing an electronic device 101 in a network environment 100. The electronic device 101 may be called a computing device, and the electronic device 101 may have a video editing application embedded in it, or the application may be installed by being downloaded externally.

Referring to FIG. 1, the electronic device 101 in the network environment 100 may communicate with an electronic device 102 through a first network 198 (e.g., short-range wireless communication) or communicate with an electronic device 104 or a server 108 through a second network 199 (e.g., long-range wireless communication). According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, an interface 177, a camera module 180, a power management module 188, a battery 189, and a communication module 190 that transmits and receives data via networks 198 and 199. In another embodiment, the electronic device 101 may omit at least one (e.g., the display device 160 or the camera module 180) of the components or include another component.

The processor 120 may control at least one of the other components (e.g., hardware or software components) of the electronic device 101 connected to the processor 120, for example, by driving software (e.g., a program 140) and perform processing and operation for various data. The processor 120 may process a command or data received from another component (e.g., the communication module 190) by loading the command or data in a volatile memory 132 and store result data in non-volatile memory 134. According to an embodiment, the processor 120 may include a main processor 121 (e.g., a CPU or an application processor) and a coprocessor 123 that is operated independently of it. For example, the coprocessor 123 may be additionally or alternatively mounted in the main processor 121 to consume lower power than the main processor 121. As another example, the coprocessor 123 may include a coprocessor 123 specialized for a designated function (e.g., a graphic processing device, an image signaling processor, a sensor herb processor, or a communication processor). Herein, the coprocessor 123 may be operated independently of or by being embedded in the main processor 121.

In this case, the coprocessor 123 may control at least some functions or states associated with at least one (e.g., the display device 160 or the communication module 190) of the components of the electronic device 101, instead of the main processor 121 while the main processor 121 is in an inactive (e.g., sleep) state. As another example, the coprocessor 123 may control at least some functions or states associated with at least one of the components of the electronic device 101, along with the main processor 121 while the main processor 121 is in an active (e.g., application operating) state.

According to an embodiment, the coprocessor 123 (e.g., an image signaling processor or a communication processor) may be implemented as a component of another functionally associated component (e.g., the camera module 180 or the communication module 190). The memory 130 may store various data used by at least one component (e.g., the processor 120), that is, input data or output data for software (e.g., the program 140) and a command associated therewith. The memory 130 may include the volatile memory 132 or the non-volatile memory 134.

As software stored in the memory 130, the program 140 may include, for example, an operating system 142, middle ware 144 or an application 146. The application 146 may have multiple pieces of software according to various functions and have a content editing application according to the present disclosure. The editing application may be executed through the processor 140, and it may be software that creates a new image or selects and edits an existing image.

The input device 150 is a device for receiving a command or data to be used for a component (e.g., the processor 120) of the electronic device 101 from the outside (e.g., a user) of the electronic device 101. The input device 150 may include a microphone, a mouse or a keyboard.

The sound output device 155 may be a device for outputting an acoustic signal to the outside of the electronic device 101. The sound output device 155 may include a speaker used for a general purpose like multimedia play or playback and a receiver used exclusively for receiving telephone calls. According to an embodiment, a receiver may be integrated with or separate from a speaker.

The display device 160 may be a device for visually provide a user with information of the electronic device 101. The display device 160 may include, for example, a display, a hologram device, or a projector and a control circuit for controlling the device. According to an embodiment, the display device 160 may include touch circuitry or a pressure sensor capable of measuring a pressure intensity for a touch. Correspondingly, based on touch circuitry or a pressure sensor, the display device 160 may detect a coordinate of a touched input region, the number of touched input regions and a touched input gesture, and provide a detection result to the main processor 121 or the coprocessor 123.

The audio module 170 may bidirectionally convert a sound and an electrical signal. According to an embodiment, the audio module 170 may obtain a sound through the input device 150 or output a sound through the sound output device 155 or an external electronic device (e.g., the electronic device 102 (e.g., a speaker or a headphone)) wired or wirelessly connected to the electronic device 101.

The interface 177 may support a designated protocol capable of wired or wireless connection to an external electronic device (e.g., the electronic device 102). According to an embodiment, the interface 177 may include a high definition multimedia interface (HDMI), a universal serial bus (USB) interface, a SD card or an audio interface.

A connection terminal 178 may include a connected capable of physically connecting the electronic device 101 and an external electronic device (e.g., the electronic device 102), for example, a HDMI connector, a USB connector, a SD card connector or an audio connector (e.g., a headphone connector).

The camera module 180 may shoot a still image and a moving image. According to an embodiment, the camera module 180 may include one or more lenses, an image sensor, an image signal processor or a flash.

The power management module 188 is a module for managing power supplied to the electronic device 101 and may be, for example, a part of a power management integrated circuit (PMIC).

The battery 189 is a device for supplying power to at least one component of the electronic device 101 and may include, for example, a non-rechargeable primary cell, a rechargeable secondary cell or a fuel cell.

The communication module 190 may establish a wired or wireless communication channel between the electronic device 101 and an external electronic device (e.g., the electronic device 102, the electronic device 104, or the server 108) and support the execution of communication through the established communication channel. The communication module 190 may include one or more communication processors that are operated independently of the processor 120 and support wired or wireless communication. According to an embodiment, the communication module 190 may include a wireless communication module 192 (e.g., a cellular communication module, a short-range wireless communication module, or a global navigation satellite system (GNSS)) or a wired communication module 194 (e.g., a local area network (LAN) communication module, or a power line communication module) and communicate with an external electronic device by using a corresponding communication module through a first network 198 (e.g., a short-range communication network like Bluetooth, BLE (Bluetooth Low Energy), WiFi direct or IrDA (Infrared Data Association)) or a second network 199 (e.g., a long-range communication network like a cellular network, the Internet or a computer network (e.g., LAN or WAN)). The various types of communication modules 190 described above may be implemented as a single chip or separate chips respectively.

Among the above components, some components may exchange a signal (e.g., a command or data) by being connected with each other through a communication type (e.g., bus, general purpose input/output (GPIO), serial peripheral interface (SPI)) among peripheral devices or a mobile industry processor interface (MIPI).

According to an embodiment, a command or data may be transmitted or received between the electronic device 101 and the external electronic device 104 through the server 108 connected to the second network 199. Each of the electronic devices 102 and 104 may be a device of a same type as or a different type from the electronic device 101. According to an embodiment, at least some of the operations performed in the electronic device 101 may be performed in another external electronic device or in a plurality of external electronic devices. According to an embodiment, when the electronic device 101 should execute a specific function or service either automatically or at a request, the electronic device 101 may request at least some functions associated with the function or service to an external electronic device either additionally or instead of executing the function or service by itself. When receiving the request, the external electronic device may execute the requested function or service and deliver a corresponding result to the electronic device 101. The electronic device 101 may provide the requested function or service by processing the received result either as it is or additionally. To this end, for example, cloud computing technology, distributed computing technology, or client-server computing technology may be used.

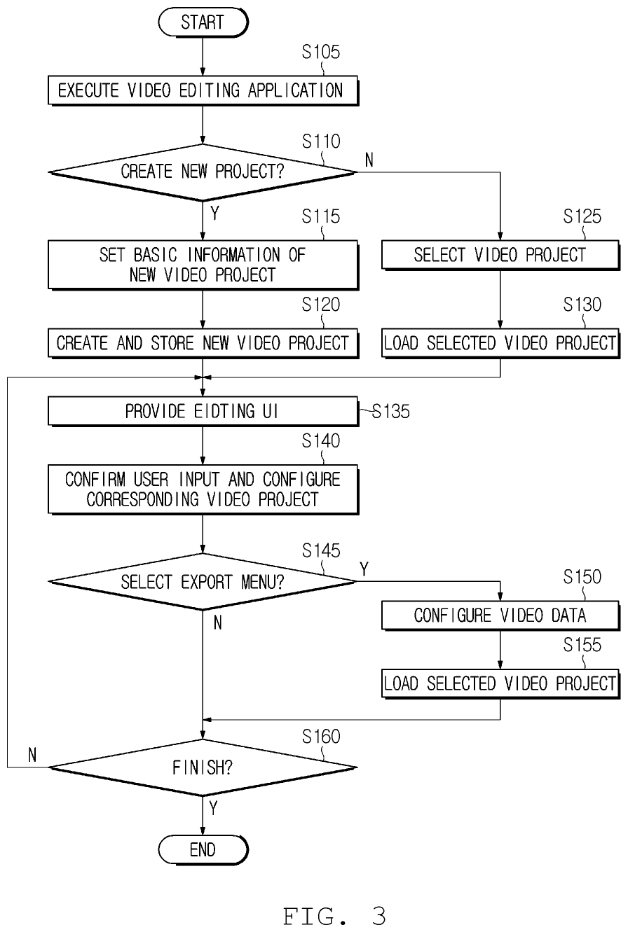

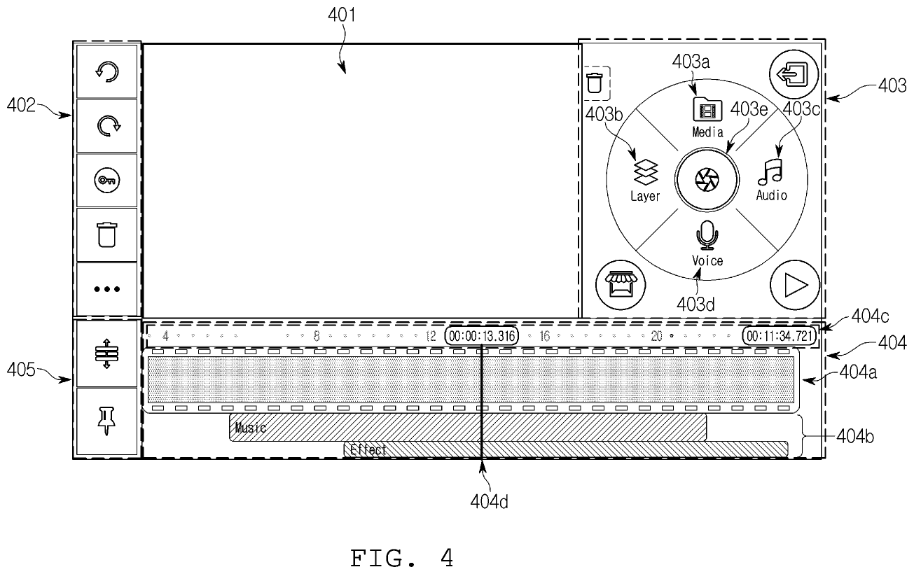

FIG. 2 is a view for describing a system hierarchy of an electronic device to which various embodiments of the present disclosure are applied.

Referring to FIG. 2, an electronic device 200 may be configured by including a hardware layer 201 corresponding to the electronic device 100 of FIG. 1, an operating system (OS) layer 200 as an upper layer of the hardware layer 210 for managing the hardware layer 210, and a framework layer 230 and an application layer 240 as upper layers of the OS layer 220.

The OS layer 220 performs functions to control the overall operation of the hardware layer 210 and manage the hardware layer 210. That is, the OS layer 220 is a layer executing basic functions including hardware management, memory and security. The OS layer 220 may include a display driver for driving a display device, a camera driver for driving a camera module, an audio driver for driving an audio module and any similar driver for operating or driving a hardware device installed in an electronic device. In addition, the OS layer 220 may include a runtime and a library accessible to a developer.

There is the framework layer 230 as an upper layer of the OS layer 220, and the framework layer 230 performs a role of linking the application layer 240 and the OS layer 220. That is, the framework layer 230 includes a location manager, a notification manager and a frame buffer for displaying a video on a display unit.

The application layer 240 for implementing various functions of the electronic device 100 is located in an upper layer of the framework layer 230. For example, the application layer 240 may include various application programs like a call application 241, a video editing application 242, a camera application 243, a browser application 244, and a gesture application 245.

Furthermore, the OS layer 220 may provide a menu or UI capable of adding or deleting at least one application or application program included in the application layer 240 and thus at least one application or application program included in the application layer 240 may be added or deleted by a user. For example, as described above, the electronic device 100 of FIG. 1 may be connected to another electronic device 102 and 104 or the server 108 via communication. At a user's request, the electronic device 100 may receive and store data (that is, at least one application or application program) from the another electronic device 102 and 104 or the server 108 and include the data in a memory. Herein, the at least one application or application program stored in the memory may be configured and operated in the application layer 240. In addition, at least one application or application program may be selected by a user through a menu or UI provided by the OS layer 220. The at least one application or application program thus selected may be deleted.

Meanwhile, when a user control command input through the application layer 240 is input into the electronic device 100, as the input control command is delivered from the application layer 240 to the hardware layer 210, a specific application corresponding to the command may be implemented and a corresponding result may be displayed in the display device 160.

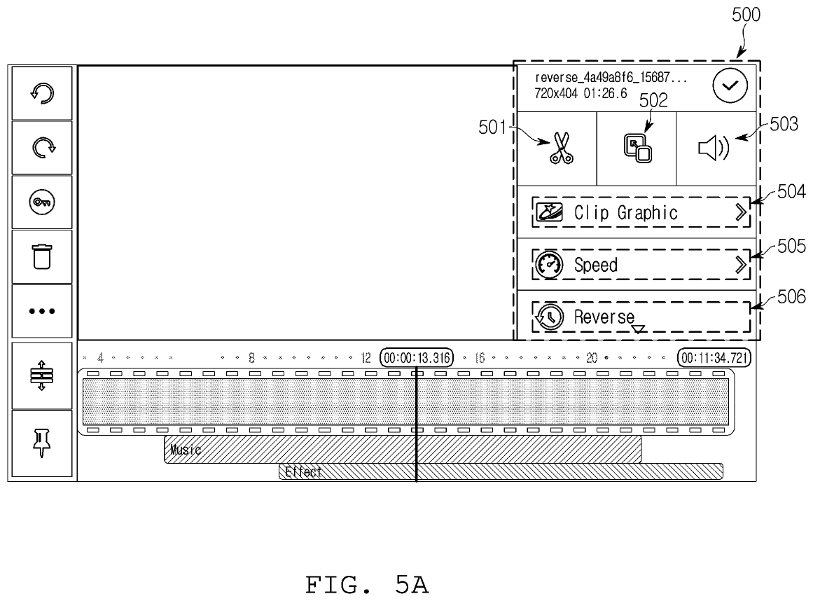

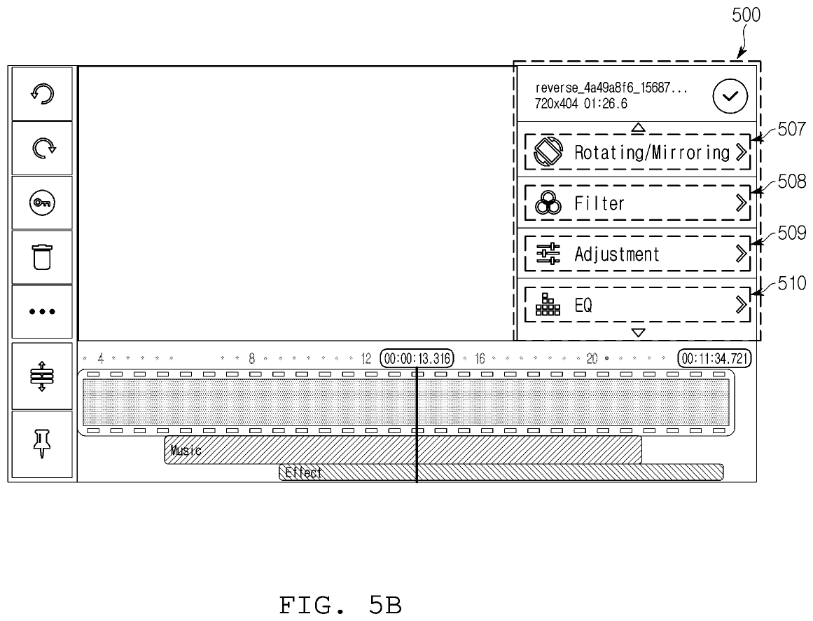

FIG. 3 is a flowchart exemplifying an order of a video editing method to which various embodiments of the present disclosure are applied.

Referring to FIG. 3, first, a video editing method may be implemented by the above-described electronic device (or computing device), and the implementation may start, when a video editing application is selected and implemented by a user input (S105).

When the video editing application is executed, the electronic device may output an initial screen of the video editing application to a display device (e.g., display). An initial screen may provide a menu (or UI) for creating a new video project and a video project selection menu (or UI) for selecting a video project already being edited. In such an initial screen, when a menu (or UI) for creating a new video project is selected, the step S115 may be performed, and when a video project selection menu (or UI) is selected, the step S125 may be performed (S110).

At step S115, the electronic device may provide a menu (or UI) for setting basic information of a new video project and set and apply the basic information input through the menu (UI) to the new video project. For example, basic information may include a screen ratio of a new video project. Based on this, the electronic device may provide a menu (or UI) for selecting a screen ratio like 16:9, 9:16 and 1:1 and set and apply a screen ratio input through the menu (UI) to a new video project.

Next, by reflecting basic information set in step S115, the electronic device may create a new video project and store the new video project thus created in a storing medium (S120).

Although an embodiment of the present disclosure presents an example screen ratio as basic information, the present disclosure is not limited to the embodiment, which may be modified in various ways by those skilled in the art. For example, an electronic device may provide a menu (or UI) for setting at least one of the automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. The electronic device may set a value input through the menu (or UI) as basic information of a new video project.

For another example, an electronic device may automatically set predetermined values for automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. In addition, an electronic device may provide a setting menu (or UI) and receive inputs of control values for automatic control of master volume, a master volume size, a basic audio fade-in setting, a basic audio fade-out setting, a basic video fade-in setting, a basic video fade-out setting, a basic setting of an image clip, a basic setting of a layer length, and basic settings of image clip pan & zoom. The electronic device may also set the above-described basic information according to the input values.

Meanwhile, at step S115, the electronic device may provide a project list including a video project stored in the storing medium and an environment in which at least one video project included in the project list may be selected. Through the above-described environment, a user may select at least one video project included in the project list, and the electronic device may load at least one video project selected by the user (S130).

At step S135, the electronic device may provide an editing UI. As exemplified in FIG. 4, the editing UI may include a video display window 401, a media setting window 402, a media input window 403, a clip display window 404, and a clip setting window 405. In an editing UI, a video display window, a media setting window and a media input window may appear in the upper part of the display, while a clip display window and a clip setting window may appear in the lower part of the display.

The media setting window may include an export menu, a capture menu and a setting menu, and the export menu, the capture menu and the setting menu may be provided in forms of icon or text enabling these menus to be recognized.

The media input window may include a media input menu 403A, a layer input menu 403B, an audio input menu 403C, a voice input menu 403D and a shooting menu 403E. The media input menu 403A, the layer input menu 403B, the audio input menu 403C, the voice input menu 403D and the shooting menu 403E may be provided in forms of icon or text enabling these menus to be recognized. In addition, each menu may include a sub-menu. When each menu is selected, the electronic device may configure and display a corresponding sub-menu.

For example, the media input menu 403A may be connected to a media selection window as a sub-menu, and the media selection window may provide an environment in which media stored in a storing medium can be selected. The media selected through the media selection window may be inserted into and displayed in a clip display window. The electronic device may confirm a type of media selected through the media selection window, and it may set a clip time of the media and insert and display the clip time in the clip display window by considering the confirmed type of media. Here, the type of media may include an image, a video and the like. When the type of media is an image, the electronic device may confirm a basic set value of length of an image clip and set an image clip time according to the basic set value of length of the image clip. In addition, when the type of media is a video, the electronic device may set a video clip time according to a length of the medium.

The layer input menu 403B may include, as sub-menus, a media input menu, an effect input menu, an overlay input menu, a text input menu, a media input menu, and a drawing input menu.

A media input menu may be configured in a same way as the above-described media input menu.

An effect input menu may provide an environment to select a blurring effect, a mosaic effect, a noise effect, a sandstorm effect, a melting point effect, a crystal effect, a star filter effect, a display board effect, a haze effect, a fisheye lens effect, a magnifying lens effect, a flower twist effect, a night vision goggle effect, and a sketch effect. An effect selected through the effect input menu may be inserted and displayed in a clip display window. Herein, an electronic device may confirm a basic set value of layer length and set an effect clip time according to the basic set value of layer length.

An overlay input menu may provide an environment to select various forms or shapes of stickers and icons. A sticker and an icon selected through the overlay input menu may be inserted and displayed in a clip display window. Herein, an electronic device may confirm a basic set value of layer length and set clip time for sticker, icon and the like according to the basic set value of layer length.

A text input menu may provide an environment to input a text, that is, a QWERTY keyboard. A text selected through the text input menu may be inserted and displayed in a clip display window. Herein, an electronic device may confirm a basic set value of layer length and set a text clip time according to the basic set value of layer length.

A drawing input menu may provide a drawing area to a video display window and be configured such that a drawing object is displayed in a touch input area of the video display window. A handwriting input menu may include, as sub-menus, a drawing tool selection menu for selecting a drawing tool, a color selection menu for selecting a drawing color, a thickness setting menu for setting thickness of a drawing object, a partial delete menu for deleting a created drawing object, and an entire delete menu for deleting an entire object that has been drawn. In addition, when a handwriting input menu is selected, an electronic device may confirm a basic set value of layer length and set a drawing object clip time according to the basic set value of layer length.

The audio input menu 403C may be connected to an audio selection window as a sub-menu, and the audio selection window may provide an environment to select an audio file stored in a storage medium. An audio file selected through the audio selection window may be inserted and displayed in a clip display window.

The voice input menu 403d may be a menu for recording a sound input through a microphone. When the voice input menu is selected by the user, an electronic device may detect an audio signal input through a microphone by activating the microphone included in the electronic device. In addition, the electronic device may show a start recording button. When the start recording button is input, audio signals may start being recorded. Furthermore, the electronic device may visually display audio signals input through the microphone. For example, the electronic device may confirm a size or frequency feature of an audio signal and display the feature thus confirmed in a form of level meter or graph.

The shooting menu 403E may be a menu for shooting an image or a video that is input through a camera module provided in an electronic device. The shooting menu 403E may be shown by an icon or the like visualizing a camera device. The shooting menu 403E may include an image/video shooting selection menu, as a sub-menu, for selecting a camera for capturing an image or a camcorder for shooting a video. Based on this, when the shooting menu 403e is selected by the user, the electronic device may display the image/video shooting selection menu. In addition, the electronic device may activate an image shooting mode or a video shooting mode of a camera module according to what is selected through the image/video shooting selection menu.

The clip display window 404 may include at least one clip line for displaying clips corresponding to media, effects, overlays, texts, drawings, audio or speech signals that are input through the media input window.

A clip line may include a main clip line 404a and a sub clip line 404b. The main clip line 404a may be a clip line provided at the top of a clip display window, and the sub clip line 404b may be at least one clip line provided below the main clip line 404a.

An electronic device may display the main clip line 404a by fixing the main clip line 404a at the top of a clip display window. The electronic device may confirm a drag input in an area, in which the sub clip line 404b exists, and display the sub clip line 404b by scrolling the sub clip line 404b up and down in response to a direction of the drag input.

Furthermore, when the direction of the drag input is an upward direction, the electronic device may display the sub clip line 404b by moving the sub clip line 404b to an upper area, and when the direction of the drag input is a downward direction, the electronic device may display the sub clip line 404b by moving the sub clip line 404b to a lower area. In addition, the electronic device may differently display the vertical width of the main clip line 404b in response to the movement of the sub clip line 404b. For example, when the sub clip line 404b moves upwards, the vertical width of the main clip line 404a may be decreased to be displayed, and when the sub clip line 404b moves downwards, the vertical width of the main clip line 404a may be increased to be displayed.

In particular, a clip display window may include a time display line 404c for indicating a time of a video project and a play head 404d. The time display line 404c may be displayed on top of the main clip line 404a described above and include figures or ticks in predetermined units. In addition, the play head 404d may be displayed as a vertical line starting from the time display line 404c to the bottom of the clip display window, and the play head 404d may be shown in a color (e.g., red) that may be easily recognized by the user.

Furthermore, the play head 404d may be provided with a fixed form in a predetermined area, and objects included in the main clip line 404a and the sub clip line 404b and the time display line 404c, which are provided in the clip display window, may be so configured as to move horizontally.

For example, when a drag input occurs in the left and right direction in an area in which the main clip line 404a, the sub clip line 404b and the time display line 404c are located, the electronic device may move objects included in the main clip line 404a and the sub clip line 404b and the time display line 404c in the left and right direction and display them. Herein, the electronic device may configure a frame or an object corresponding to the play head 404d so as to be displayed in the video display window. Also, the electronic device 404d may confirm a detailed time (e.g., 1/1000 second unit), in which the play head is touched, and also display the confirmed detailed time in the clip display window.

In addition, the electronic device may check whether or not multiple touches occur in the clip display window, and when multiple touches occur, the electronic device may respond to the multiple touches by changing and displaying a tick or figure in a predetermined unit included in the time display line 404c. For example, when an input is detected with a gradually decreasing interval of multiple touches, the electronic device may decrease an interval of the tick or figure. When an input is detected with a gradually increasing interval of multiple touches, the electronic device may display the tick or figure by increasing the interval of the tick or figure.

The electronic device may configure the clip display window 404 such that a clip displayed in a clip line can be selected, and when the clip is selected, the electronic device may visually show that the clip is selected. For example, when the electronic device detects that a clip is selected, the electronic device may provide a clip selector to a boundary of the selected clip, and the clip selector may be displayed in a predetermined color, for example, yellow.

Preferably, when it is detected that a clip is selected, the electronic device may provide a clip editing UI capable of editing the selected clip. For example, the electronic device may display a clip editing UI in an area where the media input window 403 exists. A clip editing UI may be differently set according to the type of a selected clip. Specifically, when a type of a clip is a video clip, the electronic device configure and provide a clip editing UI 500 by including a trim/split menu 501, a pan/zoom menu 502, an audio control menu 503, a clip graphics menu 504, a speed control menu 505, a reverse control menu 506, a rotation/mirroring control menu 507, a filter menu 508, a brightness/contrast adjustment menu 509, a voice EQ control menu 510, a detailed volume control menu 511, a voice modulation menu 512, a vignette control menu 513, and an audio extraction menu 514.

A clip editing UI for each clip type may be configured based on a structure of a video editing UI.

In addition, the electronic device may further display a clip editing expansion UI 530 in an area in which a media setting window exists. A clip editing expansion UI displayed in an area of media setting window may be also differently set according to a type of a selected clip. For example, when a type of clip is a video clip, an image clip, an audio clip or a voice signal clip, the electronic device may configure and provide the clip editing expansion UI 530 including a clip delete menu, a clip copy menu and a clip layer copy menu, and when a type of clip is an effect clip, a text clip, an overlay clip or a drawing clip, the electronic device may configure and provide the clip editing expansion UI including a clip delete menu, a clip copy menu, a bring to front menu, a bring forward menu, a send backward menu, a send to back menu, a horizontal center alignment menu, and a vertical center alignment.

A clip setting window may include a clip expansion display menu 550 and a clip movement control menu 560. When the clip expansion display menu 550 is selected by the user, the electronic device may display a clip display window by expanding the window to the entire area of display. In addition, when the clip movement control menu 560 is selected, the electronic device may display a clip by moving the clip to a play head. Furthermore, the clip movement control menu 560 may include a start area movement menu or an end area movement menu, and the start area movement menu or the end area movement menu may be preferably displayed adaptively by considering the position of a play head touching a clip. For example, the electronic device may basically provide the start area movement menu, and when a clip touches the start position of a play head, the electronic device may display replace the end area movement menu in replacement of the start area movement menu.

At step S140, the electronic device may confirm a user input that is input through an editing UI, configure a corresponding video project and store the configured video project in a storage medium.

As described above, an editing UI may be configured to include an export menu in a media setting window, and when the export menu is selected by the user (Y of S145), the electronic device may configure video data by reflecting information that is configured in a video project and store the video data in a storage medium (S150).

A structure of an editing UI provided in a video editing control device according to various embodiments of the present disclosure may be configured as follows.

First, the editing UI may include basically the video display window 401, the media setting window 402, the media input window 403, the clip display window 404 and the clip setting window 405, and at least one clip selected through the media input window 403 may be displayed in the clip display window 404. In addition, as at least one clip (404a, 404b) included in the clip display window 404 is selected, clip editing menus 501 to 514 may be provided to an area in which the media input window 403 exists. Herein, the clip editing menus 501 to 514 may be adaptively provided according to structures of editing UIs of each clip type.

A video clip editing menu may include a trim/split menu, a pan/zoom menu, an audio control menu, a clip graphics menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, and an audio extraction menu.

The trim/split menu may include, as sub-menus, a trim to the left of play head menu, a trim to the right of play head menu, a split-in-play head menu, and a still image split and insertion menu.

The audio control menu may include, as sub-menus, a master volume control bar, a sound effect volume control bar, an automatic volume ON/OFF menu, a left/right balance adjustment bar and a pitch adjustment bar. In addition, the master volume control bar, the sound effect control bar, the left/right balance adjustment bar and the pitch adjustment bar may be set to support a detailed adjustment UI, and the master volume control bar, the sound effect control bar, the left/right balance adjustment bar and the pitch adjustment bar may be managed as a main editing UI. A UI that is set as a main editing UI may be configured to display a detailed adjustment UI together. As another example, a main editing UI, which is set to support a detailed adjustment UI, may be configured to activate the detailed adjustment UI, when a touch input occurs for over a predetermined time (e.g., 1 second) in an area in which the main editing UI exists.

The clip graphics menu may be configured to select at least one graphic to be inserted into a clip.

The speed control menu may include at least one predetermined speed control button (e.g., 1×, 4× and 8×), a speed control bar, a mute ON/OFF menu and a pitch maintenance ON/OFF menu. In addition, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to a video.

The brightness/contrast/gamma control menu may include a brightness control bar, a contrast control bar and a gamma control bar as sub-menus in order to control brightness/contrast/gamma values of a video, and the brightness control bar, the contrast control bar and the gamma control bar may be managed as main editing UIs and be set to support a detailed adjustment UI.

The rotation/mirroring menu may include a horizontal mirroring menu, a vertical mirroring menu, a counterclockwise rotation menu and a clockwise rotation menu as sub-menus, and the counterclockwise rotation menu and the clockwise rotation menu may be managed as main editing UIs and be set to support a detailed adjustment UI.

Being a menu for controlling a magnitude of voice included in a video, the detailed volume control menu may include a control point addition menu, a control point deletion menu and a voice control bar, and the voice control bar may be managed as a main editing UI and be configured to support a detailed adjustment UI.

A voice modulation control menu may be configured to select at least one voice modulation method to be applied to a video.

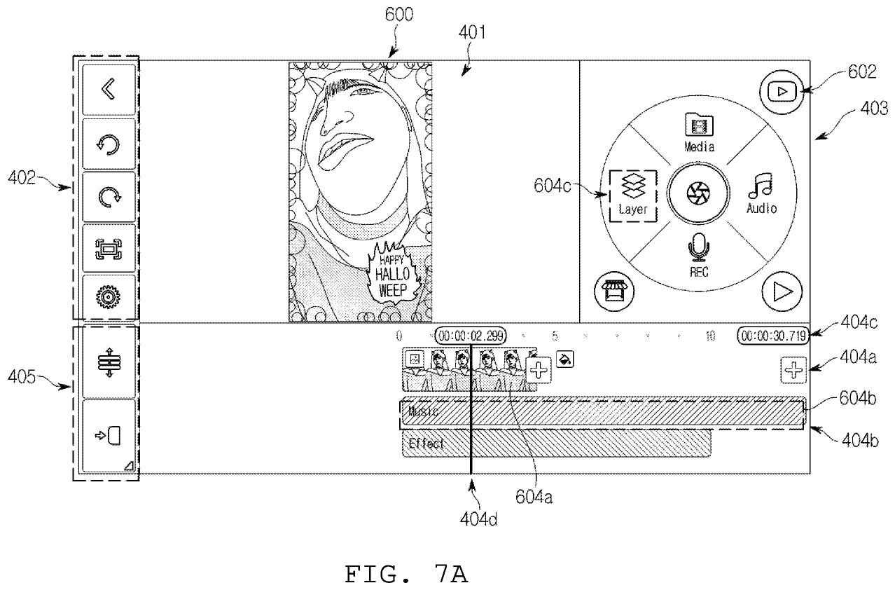

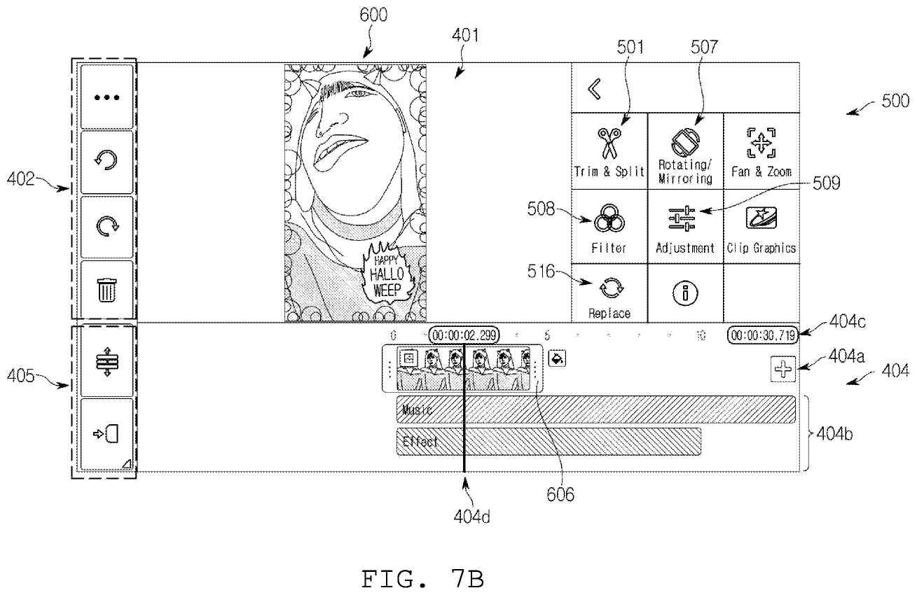

Meanwhile, an image clip editing menu may include a trim/split menu, a pan/zoom menu, a rotation/mirroring control menu, a clip graphics menu, a brightness/contrast/gamma control menu and a vignetting ON/OFF control menu, and these menus may be configured similarly to the control menu illustrated in FIG. 6A.

In addition, an effect clip editing menu may include an effect setting menu, a transparency control menu, a trim/split menu and a rotation/mirroring control menu, and the trim/split menu and the rotation/mirroring control menu may be configured similarly to a video clip editing menu. In addition, the effect setting menu and the transparency control menu may include an effect setting bar and a transparency control bar, respectively, as a sub-menu, and the effect setting bar and the transparency control bar may be managed as main editing UIs and be configured to support a detailed adjustment UI.

An overlay clip editing menu may include an overlay color setting menu, a transparency control menu, a trim/split menu, a rotation/mirroring control menu and a mixture type setting menu, and the trim/split menu and the rotation/mirroring control menu may be configured similarly to a video clip editing menu. In addition, the transparency control menu may include a transparency control bar as a sub-menu, and the transparency control bar may be managed as a main editing UI and be configured to support a detailed adjustment UI.

A text clip editing menu may include a text font setting menu, a text color setting menu, a trim/split menu, a transparency control menu, a rotation/mirroring control menu, a text alignment type setting menu, a shadow ON/OFF menu, a glow ON/OFF menu, an outline ON/OFF menu, a background color ON/OFF menu and a mixture type setting menu, and the trim/split menu, the transparency control menu and the rotation/mirroring control menu may be configured similarly to a video clip editing menu. In addition, the shadow ON/OFF menu, the glow ON/OFF menu, the outline ON/OFF menu and the background color ON/OFF menu may each include a color control bar for setting a color (e.g., R/G/B control bar) or a transparency control bar for adjusting transparency as a sub-menu, and the color control bar (e.g., R/G/B control bar) or the transparency control bar may be managed as a main editing UI and be configured to support a detailed adjustment UI.

In addition, a drawing clip editing menu may include a transparency control menu, a trim/split menu, a rotation/mirroring control menu and a mixture type setting menu, and the trim/split menu and the rotation/mirroring control menu may be configured similarly to an overlay clip editing menu. In addition, the transparency control menu may include a transparency control bar as a sub-menu, and the transparency control bar may be managed as a main editing UI and be configured to support a detailed adjustment UI.

In addition, an audio clip editing menu may include an audio control menu, a voice EQ control menu, a detailed volume control menu, a voice modulation control menu, a ducking ON/OFF control menu, a repetition ON/OFF control menu and a trim/split menu. The audio control menu, the voice EQ control menu, the detailed volume control menu, the voice modulation control menu and the trim/split menu may be configured similarly to a video clip editing menu.

FIG. 6 is a flowchart depicting a method of editing an advertising content according to an embodiment of the present disclosure.

First, like in FIG. 3, as a video editing application is selected and executed by a user input, a corresponding operation may start.

When the video editing application is executed, the electronic device may output an initial screen of the video editing application to a display device (e.g., display). An initial screen may provide a menu (or UI) for creating a new video project and a video project selection menu (or UI) for selecting a video project already being edited. In such an initial screen, when a menu (or UI) for creating a new video project is selected, an editing process for an advertising content may be performed by using a process that is similar to step S115. In addition, when a video project selection menu (or UI) is selected, an editing process for an advertising content may be performed by using a process that is similar to step S125.

Specifically, referring to FIG. 6, the user may load a project associated with an advertising content 600 by using an editing application (S205).

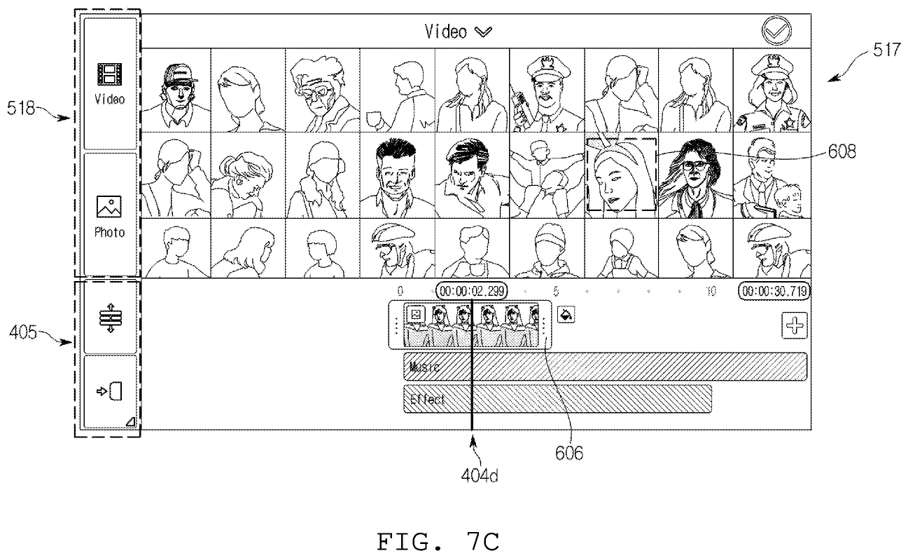

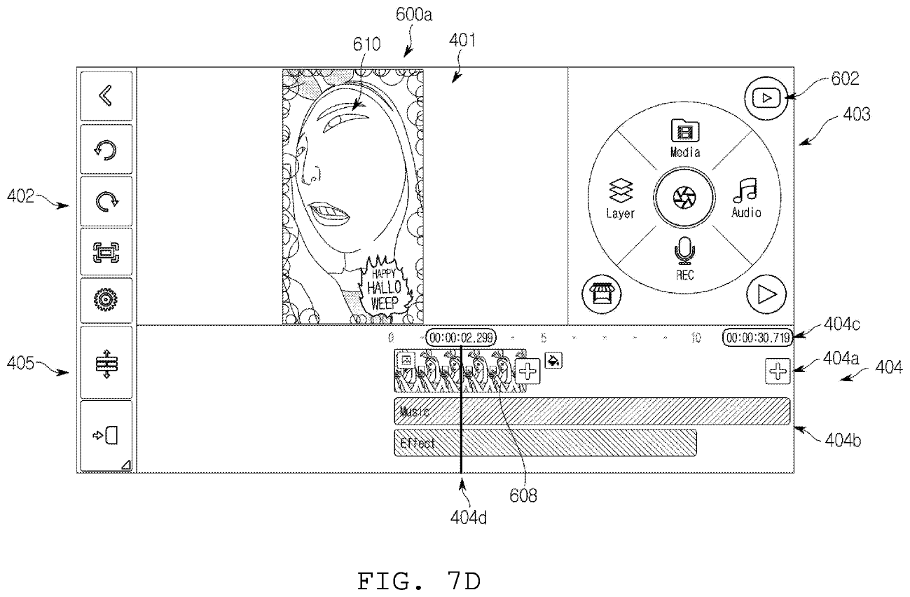

The user may access an advertising content source and obtain the advertising content (600 of FIG. 7A) by using the electronic device 101. For example, an advertising content source may be a mobile web page, a banner, a link, YouTube, VLOG, and social media and an advertising content that is served from the sources and is shared by another user. The user may load an advertising content provided from an advertising content source to a video editing application and create a new video project. As another example, the user may select and load a project associated with an advertising content that is already stored and being edited in the application.

The advertising content 600 may be configured with a media object, which is at least one of text, audio, image and video, and be an original content produced by an advertiser or a producer or a modified advertising content that is edited by another user. A media object of the advertising content 600 may include at least one of various editing elements exemplified in an effect input menu, an overlay input menu, and a drawing input menu.

Apart from a media object, the advertising content 600 may include an object that is allowed to be edited in the content, that is, an editable element as attribute information. Herein, an element may be attribute data defining at least one of a media object constituting the advertising content 600, an editing tool for editing the advertising content 600, and category information that is designated for a concept of the advertising content 600. For example, attribute data may be embodied as a form of meta data.

The elements may be arranged and combined temporally and spatially to be produced as an advertising content. In addition, respective elements may be arranged and combined by overlapping in a depth direction at a same time and a two-dimensional space, and in this case, depth information between each element may be included. The above-described arrangement and combination of elements may be referred to as a relationship of elements of an advertising content in the present specification.

An element associated with a media object may be attribute data that designates at least a part of a video displayed in the advertising content 600. In addition, an element associated with a media object may be attribute data designating at least one of music, a sound, an image frame, a graphicalized icon, a graphicalized sticker, a background image, a text, and an overlapping layer, which constitute the advertising content 600 exemplified above. In the case of a media object, an editable element may be designated as at least a part of an object (the above-described object, that is, a video, music and a sound) constituting the media object.

An element associated with an editing tool may include an editing function for giving an additional effect to a medium constituting the advertising content 600. For example, an editing tool may be editing elements that are provided in the media input window 403 and the clip editing UI 500 and add various additional effects to the medium. In this case, an editable element may be designated as at least one of a plurality of editing elements.

Category information may include at least one of a media form of the advertising content 600, connection information between media objects, and additional effect information, as a main form of determining a concept of the advertising content 600. A media form may be designated as a representative type of at least one of a plurality of types including video, audio, image and text. An object associated with an advertising concept or identity may be expressed by combining a plurality of media objects. For example, in order to express a video configuration showing a concept, a brand, a jingle, a character, a product or a specific background, media objects may be associated with each other. In this case, an advertisement producer may designate an advertising concept object as category information after creating an advertising content, and the category information may include connection information between the concept object and a related media object. In addition, additional effect information may be an additional effect associated with the advertising concept object, and an additional effect is actually the same as described above. In the case of category information, an editable element may include at least one of a media form of the advertising content 600, which allows a concept to be modified, connection information between media objects, and additional effect information that can be inserted.

In case the advertising content 600 contains only an editable element as attribute information, other element of the advertising content 600 may be considered as a non-editable element. As another example, attribute information may designate and record an editable element and a non-editable element in the advertising content 600. As yet another example, in case attribute information contains only a non-editable element in the advertising content 600 contains, other element of the advertising content 600 may be considered as a non-editable element.

Meanwhile, an editable element and/or a non-editable element may be designated by an advertisement producer and be recorded as attribute information. In an advertising content, an element that can be edited by the user and an element that cannot be edited by the user may be designated by an advertiser, a producer, and a previous editor in consideration of the advertisement identity, a concept, an effect and the like. In addition, a category for an overall form of advertising may also be designated by an advertiser, a producer, and a previous editor. Designation of such an element may be labeled in a necessary element by a producer, and a category may be set in advance when an advertising content is created by a producer and the like.

FIG. 7A to FIG. 7D are views exemplifying a process where an advertising content is edited by an advertising content editing method according to an embodiment of the present disclosure.

As in FIG. 7A, by the user's creation or selection of a project, the advertising content 600 may be provided to an application for an editing UI and be displayed in the video display window 401.

The clip display window 404 may provide the clip lines 404a and 404b for each media object of the advertising content 600. For example, a clip associated with an original image or video of the person displayed in the advertising content 600 exemplified in FIG. 7A may be placed in the main clip line 404a. In addition, a notification associated with the extortion effect of a person in the advertising content 600 may be displayed as information associated with an additional effect in the main clip line 404a but is not limited thereto. As another example, the notification may be embodied as a separate clip line or another form in the media input window 403. A clip, which is associated with music, a sub-image, a text, a sound, a sticker and an icon in the advertising content 600, may be displayed as each corresponding sub-clip line 404b.

As at least one clip (404a, 404b) included in the clip display window 404 is selected, clip editing menus 501 to 514 may be provided to an area in which the media input window 403 exists. Herein, the clip editing menus 501 to 514 may be adaptively provided according to the above-exemplified structures of editing UIs of each clip type. Detailed description has been provided above and thus will be skipped here.

Next, the electronic device with an embedded video editing application may enable the user to extract an editable element and a non-editable element from the advertising content 600 (S210).

As the editing application is executed, the processor 140 may distinguish an editable element and a non-editable element by analyzing attribute information of the advertising content 600. The processor 140 may present an editable element to any one of a media object, an editing user interface for editing the advertising content 600 and a predetermined area of the editing application.

As illustrated in FIG. 7A, it may be a human face, various images around the face, music, a special sound, a designed text like “HAPPY HALLOWEEN”, background music, a distortion effect of the human face and the like, which constitute the advertising content 600. FIG. 7A exemplifies that an editable element is present in an editing user interface. In FIG. 7A, when an editable element is a main clip line 604a associated with an original human face, a sub-clip line 604b associated with background music, and a layer input menu 604c that provides an additional effect to the advertising content 600, the processor 140 may process an editing user interface associated with the elements to visually display that it is activated.

When the user selects the layer input menu 604c, the processor 140 may visually display that at least a part of functions of an additional effect provided in a sub-menu of the menu is activated. An effect input menu in the layer input menu 604c may provide an environment to select a blurring effect, a mosaic effect, a noise effect, a sandstorm effect, a melting point effect, a crystal effect, a star filter effect, a display board effect, a haze effect, a fisheye lens effect, a magnifying lens effect, a flower twist effect, a night vision goggle effect, and a sketch effect. An editable element may be displayed as at least a part of effects applied to the advertising content 600. The above example describes activation in an effect function key. In another example, effects applied to the advertising content 600 may be displayed in the sub-clip line 404b, and an element, which becomes an editable element, may be displayed to be visually activated in the sub-clip line 404b.

Without being limited to the above example, the processor 140 may visually process an original human face so that it shows an editable element in the video display window 401. In another example, a list of an editable media object may be shown in an editing application, not the video display window 401 and the clip display window 404.

In case an editable element is category information, the processor 140 may include at least one of a media form of the advertising content 600, which allows an advertising concept to be modified, connection information between media objects, and additional effect information that can be inserted. In order to identify media objects associated with an allowable media form, connection information and additional effect information, the processor 140 may visually process the media objects so that the media objects are distinguished from other objects in the video display window 401. In another example, a clip line associated with the media objects may be visually activated in the clip display window 404. In yet another example, an additional effect function allowing a concept modification may be displayed in a sub-menu of the media input window 403, or a list of media objects, which cannot be modified due to an advertising concept, may be shown in a separate area.

Next, the user may select an editable element in the advertising content 600 (S215).

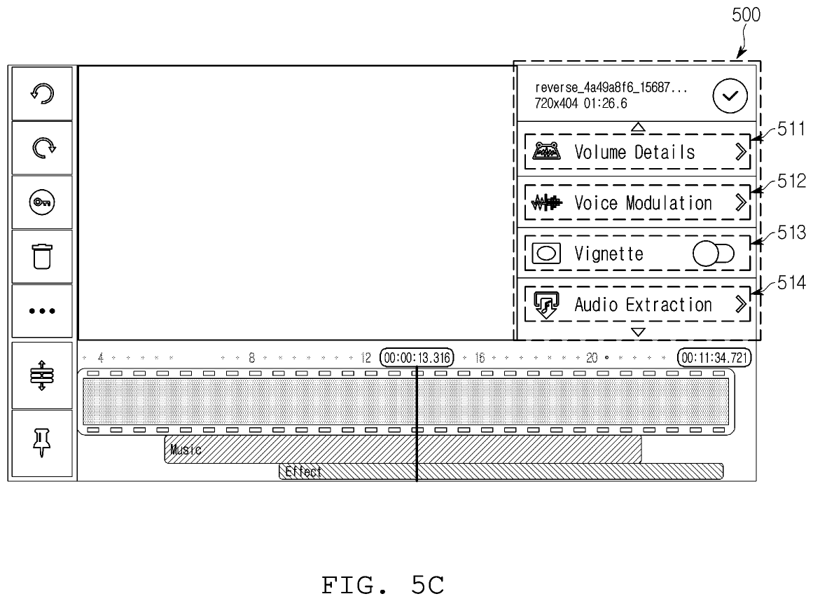

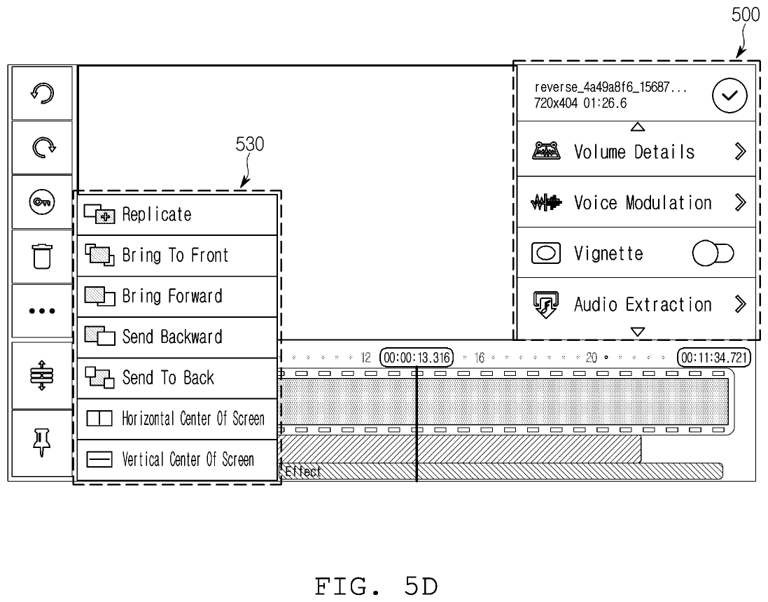

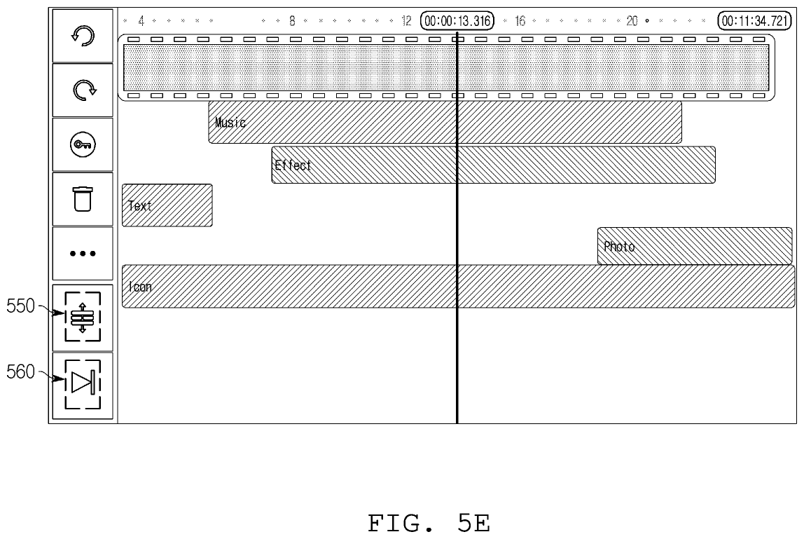

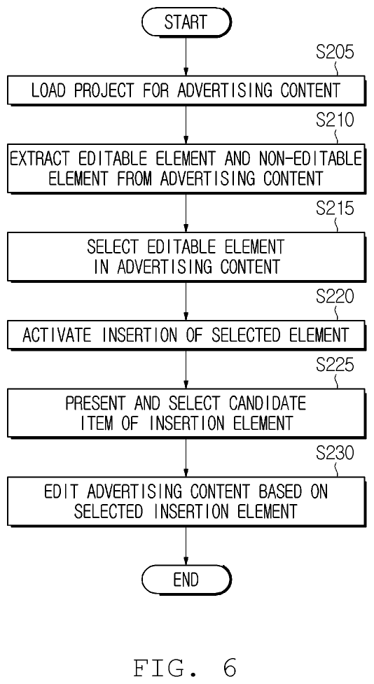

The processor 140 may present a category of an editable element and an editable range through the clip display window 404 and provide a clip editing UI exemplified in FIG. 5 through the media input window 403 when the user selects a clip. In this example, editable category information of the advertising content 600 includes all types of video, image, music and text, and a process of editing a human face, among editable elements, is exemplified. However, the present embodiment is not limited to such an example, and various editing is possible for an editable element in the advertising content 600. For example, apart from image replacement, editing may also be performed by addition of background music, voice, sticker, icon and text, a change of video frame order, an overlap of video and image at a same time and in a two-dimensional space, and a category modification within an allowable range.

As in FIG. 7B, when the user selects the main clip line 404a corresponding to an original human face as an editable element in the clip display window 404, the processor 140 may receive a user input for the selected editable element. Responding to the reception, the processor 140 may display the clip selector 606. In addition, the processor 140 may present an editable UI to a corresponding clip in the media input window 403.

Next, the processor may provide the user's insert activation request as an interface 516 in the media input window 403, and when the user selects the insert activation request, the processor 140 may activate an insert request for replacing a selected human face (S220).

In the example of FIG. 7B, an interface of an insert activation request is shown as Replace 516 in the media input window 403, and the user may activate replacement editing of the advertising content 600 by selecting Replace 516. A soft key associated with an activation request may clearly show the user that a corresponding media object is editable. In addition, in case there is a plurality of insertion elements to be replaced, the soft key may activate provision of a candidate item associated with a replacement insertion element.

Next, by the insert activation request, the processor 140 may present a plurality of candidate items, which can be inserted into an editable element, and receive a candidate item 608 that is selected by the user's input (S225).

In the example of FIG. 7C, a plurality of images to replace a human face selected as an editable element is presented as a candidate item list 517. The candidate item list may provide an object type button 518 to be presented according to each media object type. When the user wants to select photo as an insertion element apart from video, the user may check a candidate item of photo by touching a photo interface on the object type button 518. In the case of an allowable category, a candidate item is presented according to each media object, and various concepts of categories with media objects being combined may also be presented as candidate items.

Next, the processor 140 may select a selected item as an insertion element and edit the advertising content 600 based on the insertion element (S230).

In the example of FIG. 7D, based on another human face image selected by the user, the processor 140 may perform editing by replacing an existing human face displayed in the clip display window 404 of the advertising content 600 by the selected image. In FIG. 7D, a distortion effect applied to the existing human face may be processed to be applied to the selected image 608, and thus an edited advertising content 600a may be provided in the video display window 401. An edited image 610, which combines the selected image and the distortion effect, may be created to be included in the edited advertising content 600a.

Then, through the export function mentioned in FIG. 3 or through project storage, the user may upload the edited advertising content on the contents platform 602 and share it with another user or may store the incompletely edited advertising content as a project and reedit it later.

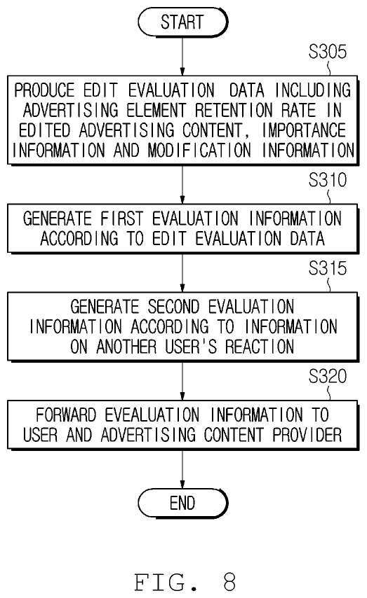

FIG. 8 is a flowchart of an evaluation process of an edited advertising content according to another embodiment of the present disclosure.

The advertising content 600a edited through FIG. 6 may be uploaded through a video editing application itself or another contents platform.

At least one of the processor 140 with an embedded application and a server of a contents platform may produce edit evaluation data for the edited advertising content 600a thus uploaded (S305).

The edit evaluation data may be produced based on at least one of an insertion element added to the edited advertising content 600a and an advertising element maintained in the advertising content 600. For example, the edit evaluation data may be generated based on at least one of a retention rate of an advertising element, importance information of an advertising element set in the advertising content 600, and modification degree information of the advertising content 600 according to an insertion element.

calculation criterion data which is used to calculate a modification degree of the edited advertising content in the modification degree information, and the importance information may be provided from a contents platform or a server of an advertisement provider.

An advertisement provider (e.g., advertisement producer) may give a high importance, that is, a weight to a specific element among editable advertising elements and categories by considering such aspects as advertisement identity, concept, and advertising effect. An element, to which a high weight is given, may be a media object, an additional effect, or a category that are expected to be exposed in as an original state as possible. A weight may be presented to a user during an editing process of an advertising content in FIG. 6, and the user may edit even an editable element with high importance according to an advertising effect and his own intention. Irrespective of a reaction that the edited advertising content 600a causes in another user, the contents platform or the processor 140 may identify at least one of a media object, an additional effect and a category, which are retained in the advertising content 600, and calculate a ratio of retained elements in the whole advertising content and their importance. In addition, along with a degree of modification for an edited element, a change rate of importance may be calculated according to the degree of modification.

Specifically, an advertiser may generate importance information by setting a weight associated with an advertisement concept for each editable element. In case an editable element with a high weight is replaced by an insertion element, edit evaluation data may be produced to be lower than an element with a lower weight.

Information on a degree of modification may include a degree of separation to which a replacing insertion element in an editable element is modified in relation to an original element. For example, in the case of image replacement, a degree of disparity may be a degree of change calculated by the analysis of video machine learning based on calculation criteria data for a concept or identity of an original image. In the case of music replacement, a degree of disparity may be a degree of change for a musical mood, a tempo and the like based on calculation criteria data for original music.

Next, the processor 140 or a server may generate first evaluation information according to edit evaluation data (S310).

Next, second evaluation information may be generated by collecting another user's reaction information for the edited advertising content 600a (S315).

For example, after the edited advertising content 600a is uploaded, as for reaction information in a contents platform and a server of an advertisement provider, second evaluation information may be derived by evaluating the edited advertising content 600a in consideration of a reaction of another user, an advertising effect, and an actual sales history according to advertising. The reaction of another user may be calculated based on, for example, preference evaluation, favorable comments and the like.

First evaluation and second evaluation according to steps S310 and 315 described above may be performed in a different order from FIG. 8, for example, in a reverse order or in a same step, and a weight according to first and second evaluation information may also be set according to a situation.

Next, the first and second evaluation information may be forwarded to the user's electronic device 101 and a server of an advertising content provider (S320).

Thus, according to at least any one of the first evaluation information and the second evaluation information, an advertisement provider may quantitatively analyze advertising effects for the original advertising content 600 and the edited advertising content 600a. In addition, the user may gain various benefits through an advertiser, an application operator, an advertisement agency and the like.

The above embodiment takes an advertising content as an example content, but as long as the characteristic of the content is damaged, the content may include any common content created by an individual user as well as advertisement.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A method for editing an advertising content, performed by a computing device comprising at least one processor, the method:
extracting an editable element from a loaded advertising content and presenting the editable element;
receiving, by a user input, the presented editable element;
selecting, by the user input, an insertion element for the editable element; and
editing the advertising content based on the selected insertion element.

2. The method of claim 1, wherein the editable element includes at least one of a media object constituting the advertising content, an editing tool for editing the advertising content, and category information that is designated for a concept of the advertising content.

3. The method of claim 2, wherein the editing tool includes an editing function for giving an additional effect to a medium constituting the advertising content.

4. The method of claim 2, wherein the category information includes at least one of a media form of the advertising content, which allows the concept to be modified, connection information between the media object, and information on an insertable additional effect.

5. The method of claim 2, wherein the presenting of the editable element comprises presenting the editable element to at least one of the media object, an editing user interface for editing the advertising content, and a predetermined area of an editing application that the computing device provides.

6. The method of claim 1, wherein the extracting of the editable element comprises extracting the editable element based on attribute information included in the advertising content, and
wherein the attribute information records an editable element and a non-editable element as distinguished in the advertising content.

7. The method of claim 1, wherein the receiving of the editable element comprises receiving the user input, which selects the editable element, and receiving an insertion activation request according to the user input for the editable element.

8. The method of claim 1, wherein the selecting of the insertion element comprises presenting a plurality of candidate items, which are insertable into the editable element, and receiving a candidate item selected by the user input.

9. The method of claim 1, further comprising:
sharing the edited advertising content through a contents platform;
generating evaluation information by evaluating the shared edited advertising content; and
forwarding the evaluation information to the computing device and a server associated with provision of the advertising content.

10. The method of claim 9, wherein the generating of the evaluation information comprises generating first evaluation information based on at least one of an insertion element added to the edited advertising content and an advertising element maintained in the advertising content.

11. The method of claim 10, wherein the first evaluation information is generated based on at least one of a retention rate of the advertising element, importance information of the advertising element set in the advertising content, and modification degree information of the advertising content according to the insertion element.

12. The method of claim 11, wherein the first evaluation information is generated by at least one of the computing device and the server, and
wherein calculation criterion data in the modification degree information, which is used to calculate a modification degree of the edited advertising content, and the importance information are provided from the server.

13. The method of claim 9, wherein the generating of the evaluation information further comprises generating second evaluation information by collecting reaction information for the edited advertising content from another user of the contents platform.

14. A computing device for editing an advertising content, the computing device comprising:
a communication module; and
a processor configured to control the computing device by transmitting to and receiving from the communication module,
wherein the processor is further configured to:
present an editable element from a loaded advertising content,
receive the presented editable element by a user input,
select a replacement element for the editable element by the user input, and
edit the advertising content based on the selected replacement element.
